(19) United States
(12) Patent Application Publication
(10) Pub. No.: US 2008/0033106 A1
(43) Pub. Date: Feb. 7, 2008

(54) Composition for improving wettability of surfaces

(76) Inventors: Balint Koroskenyi, Peekskill, NY (US); Bingham Scott Jaynes, New City, NY (US); William J. Peer, Patterson, NY (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/881,721

(22) Filed: Jul. 27, 2007

Related U.S. Application Data
(60) Provisional application No. 60/835,217, filed on Aug. 3, 2006.
(60) Provisional application No. 60/932,397, filed on May 31, 2007.

(51) Int. Cl. C08G 67/02

(52) U.S. Cl. 524/801; 528/392

(57) ABSTRACT

The invention is directed to a method for improving the wettability/hydrophilicity of hydrophobic substrates by applying block copolymers to said substrates wherein the block copolymers comprise a quaternary ammonium polymer block and a hydrophobic block. The method of the invention is especially advantageous when used to improve the wettability of non-wovens and in the treatment of hydrophobic surfaces encountered in the home to prevent the buildup of soil residues.

This application takes the benefit of U.S. Provisional Application Nos. 60/835,217, filed Aug. 3, 2006 and 60/932,397, filed May 31, 2007.

### FIELD OF THE INVENTION

The invention is directed to a method for improving the wettability/hydrophilicity of hydrophobic substrates by applying a composition comprising an amphiphilic block copolymer to the substrate wherein the amphiphilic block copolymer comprises a hydrophilic (A) block and a hydrophobic (B) block. The hydrophilic block (A) comprises a cationic monomer unit formed from vinylic or allylic amines or their quaternary salts and the hydrophobic polymeric block (B) is formed from hydrophobic ethylenically unsaturated monomers. The method of the invention is especially advantageous when used to improve the wettability of non-wovens and in the treatment of hydrophobic surfaces encountered in the home to prevent the buildup of soil residues (hard surface cleaners).

### BACKGROUND

Polymers are used extensively to make a variety of products which include blown and cast films, extruded sheets, injection molded articles, foams, blow molded articles, extruded pipe, monofilaments, fibers and non-woven webs. Some plastics, such as polyolefins, are naturally hydrophobic. There are a number of uses for plastics where their hydrophobic nature either limits their usefulness or requires some effort to modify the surface characteristics of the shaped articles made therefrom.

By way of example, polyolefins, such as polyethylene and polypropylene, are used to manufacture polymeric fabrics which are employed in the construction of such disposable absorbent articles as diapers, feminine care products, incontinence products, training pants, wipes, and so forth. Frequently, such polymeric fabrics need to be wettable by water or aqueous-based liquids. Wettability can be obtained by spraying or otherwise coating (i.e., surface treating or topically treating) the fabric with a surfactant solution during or after its formation, and then drying the web.

Polyolefinic fibers are also used in carpets and the like. Dyeing of these fibers or carpets presents a challenge because of the hydrophobic nature of the fibers. Thus wetting with aqueous dye solutions is often difficult.

Another problem encountered from hydrophobic substrates is the buildup of soils commonly encountered in household use such as on vinyl, polycarbonates, polyolefins or polymethylmethacrylates used in kitchens and bathroom. When these hydrophobic surfaces are cleaned, usually with water solutions containing a detergent and other additives, de-wetting occurs on the hydrophobic surface causing streaking/filming potential. Thus a method for reducing the hydrophobic nature of the substrate would help in giving better surface appearance. For example, in the context of a “daily shower” spray application, decreasing the hydrophobicity by directly spraying onto plastic or polymeric surfaces, or onto wet surfaces, and then drying, the next exposure to water, e.g., during a shower, the dried-on, though not visible, residue allows for even faster wetting of the surface and easier cleaning.

In these cases the low level of residue (residue being defined as non-volatile actives) makes next time cleaning even easier by providing even better wetting upon subsequent application, thus reducing streaking/filming potential by minimizing solution de-wetting which is particularly important on very hydrophobic surfaces. An effective wetting benefit might allow the formulator to keep other ingredients in the composition, such as surfactants, that are typically involved in wetting, at a minimum. This reduces the possibility of obtaining a film that can smudge and/or cause surface stickiness due to the presence on the surface of too much active and/or other material.

Amphiphilic block copolymers per se are well known in the art. For example, amphiphilic block copolymers comprising a polyolefinic segment and a cationic segment are known. For example, Sandrine, L. et. al., .J of Polymer Science: Part A Polymer Chemistry, Vol. 44, 1214-1224 disclose quaternized diblock copolymers of ethylene-co-butylene and 2-(dimethylamino)ethylmethacrylate. Zhang, X et al. Macromolecules, 1999, 32, 1763-1766 and Khelfallah, N. S. et al, Polymer Bulletin 53, 295-304 (2005) disclose diblock copolymer of styrene and 2-(dimethylamino)ethylmethacrylate. Allen, A. J et al. Designed Monomers and Polymer, Vol. 2, 29-52 (1999) discloses grafted isobutylene with 2-(dimethylamino)ethyl methacylate.

Macromolecules, 2005, Vol. 38, p 7580-7592 discuss amphiphilic block copolymers which consist of a hydrophobic block and a hydrophilic block and show specific examples of block copolymers containing cationic blocks with (meth)acrylate ester blocks.

Narrainen, A. et al., J. of Polymer Science: part A: Polymer Chemistry, Vol. 40, 439-450 (2002) discloses block copolymers of poly n-butyl methacrylate and quaternized poly[2-dimethylamino)ethyl methacrylate. Tal'rose, R. V et. al. Macromol. Rapid Commun. 19, 517-522 (1998) discloses poly-(N,N-diallyl-dimethyl ammonium chloride)-block-poly cetylacrylate polymers.

Batt-Coutro, D. et al, European Polymer Journal 39 (2003) 2243-2252 discloses amphiphilic cationic block copolymers wherein the hydrophobic block is polyvinyl acetate and the cationic block is quaternized poly[2-(dimethylamino)ethyl methacrylate]. Achileos M. et al., Polymer Preprints, 2006, 47(2), 640 discloses amphiphilic block copolymer comprising a hydrophilic poly[2-(dimethylamino)ethyl methacrylate] segment and either a polystyrene, polybutylacrylate of polybutylmethacrylate hydrophobic segment.

There is no suggestion in any of the reference to use the block copolymers in hard surface cleaners or to use the block copolymers to treat non-wovens to improve wettability.

Block copolymers are also known as modifiers for surfaces. For example, U.S. Pat. No. 5,464,691 discloses the use of an amphiphilic resin towards modifying the surface energy of a polyolefin. The amphiphilic resins are composed of hydrocarbon sections and a polar section. The hydrocarbon sections are derived from, for example, long-chain aliphatic carboxylic acids and the polar section is derived from a telechelic diol, for example polyethylene glycol.

U.S. Pat. Nos. 5,240,985, 5,272,196, 5,281,438, 5,328,951 disclose the use of an amphiphile towards increasing the surface energy of polyolefins. The amphiphile consists of a central hydrophilic component and two lipophilic components. The hydrophilic component is derived from, for example, polyglycols and the lipophilic components are derived from, for example fatty acids.

Block copolymers are also known in detergents and as suds enhancers. For example, U.S. Pat. No. 6,864,314 discloses block polymeric materials which may be cationically charged. The polymeric material is used as a suds enhancer.

U.S. Pat. No. 6,437,040 discloses amphiphilic block copolymers as wetting agents or hydrophilization agents for the coating of more or less hydrophobic surfaces with a persistent effect after rinsing.

The inventors have discovered that by treating a hydrophobic substrate with a particular amphiphilic block copolymers comprising an hydrophilic block (A) and a hydrophobic block (B), the surfaces may be made hydrophilic. Thus, hydrophobic surfaces such as polyalkylene terephthalate, for example poly(ethylene.terephthalate) and poly(butylene terephthalate, and polypropylene non-wovens become wettable.

Hard substrates such as polyvinyl chloride, polycarbonates, polypropylene and polymethylmethacrylate present on countertops, bathrooms and kitchens can be made wettable, improving the cleaning characteristics of the hydrophobic surface.

Synthetic fabrics or carpets formed from hydrophobic polymers such as polyamides (nylon for example), polyolefins such as polypropylene, polyesters such as polyethyleneterephthalate and polybutylene adipate, and polyacrylonitrile may also be made wettable for purposes of dyeing or printing.

### SUMMARY OF THE INVENTION

The invention is directed to a method for improving the wettability/hydrophilicity of hydrophobic substrates comprising the steps of

applying a composition comprising an amphiphilic block copolymer to the substrate, wherein the amphiphilic block copolymer comprises a hydrophilic (A) block and a hydrophobic (B) block, wherein the hydrophilic block (A) comprises at least a cationic monomer unit defined by formula (I) or (II)

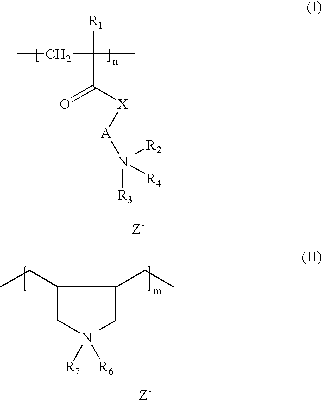

wherein R₁ is hydrogen or methyl,

### R₂ is a branched or unbranched C₁₋₄ alkyl,

### R₃ and/or R₄ are independently branched or unbranched C₁₋₂₂ alkyl, C₁-C₄ alkylhydroxy or benzyl

or

### R₃ and R₄ can be combined to form a five or six membered ring with the nitrogen, said ring containing one or more hetero atoms,

### Z⁻ is the conjugate base of an acid,

### X is oxygen or —NR₅,

wherein R₅ is as defined in R₁ above,

### A is an alkylene group of 1 to 4 carbons,

### R₆ and R₇ are branched or unbranched C₁₋₂₂ alkyl, benzyl or C₁-C₄ alkylhydroxy,

n and m are 2, 3, 4 or greater;
and
the hydrophobic polymeric block (B) is formed from ethylenically unsaturated hydrophobic monomers.

The invention also encompasses an aqueous hard surface cleaner composition comprising the amphiphilic block copolymer as described above and optionally a nonionic or ionic surfactant. Nonionic surfactants are preferred.

A third embodiment of the invention includes a fiber, non-woven, carpet or fabric coated with the amphiphilic block copolymer as described above. This coating on the fiber, non-woven, carpet or fabric substrate increases the hydrophilicity of the treated substrate thus improving its printability and dyeability.

Thus the invention embodies a method for treating a hydrophobic substrate to increase the hydrophilicity and/or wettability of the substrate by applying to the substrate a composition comprising the amphiphilic block copolymer described above. The amphiphilic block copolymer may be dispersed in an aqueous solution optionally further containing an nonionic or ionic surfactant.

A method of hard surface cleaning, which method comprises contacting a hydrophobic surface with an effective amount of a cleaning formulation comprising the amphiphilic block copolymer above.

The present invention also encompasses a method for preparation of the amphiphilic block copolymer described above. The method comprises the steps of

polymerizing a cationic monomer of formula (III) or (IV)

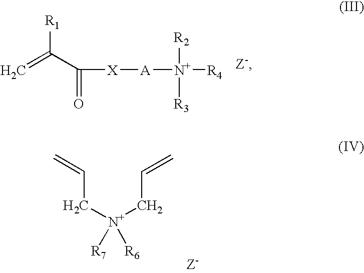

in the presence of
an hydrophobic B block polymer, which hydrophobic B block is terminated with a functional group or chain transfer group.

### DETAILED DESCRIPTION OF THE INVENTION

“Block copolymers” as used herein is meant to encompass two or more different polymeric units which are covalently linked to form a single polymer molecule. Typically, the block copolymers are in the form of di-, tri- and multi-block polymers. For example, the block copolymer may comprise a diblock copolymer such as Block A-Block B or a triblock copolymer such as Block A-Block B-Block A or Block B-Block A-Block B. An AB-AB architecture is also possible.

Thus, it is a further aspect of the present invention to provide an amphiphilic block copolymer comprising a hydrophobic block connected to a hydrophilic block wherein the hydrophilic block (A) comprises at least a monomer unit defined by formula (I) or (II) connected to a hydrophobic nonionic block (B).

A block may be defined by naming a polymer or by naming monomers it is derived from.

For purposes of the invention, a monomer unit is defined as the unit formed after polymerization.

The term monomer by itself refers to the monomer before polymerization.

A block may be a copolymer, comprising several kinds of repeating units or monomer units, deriving from several monomers. Block A and block B are different polymers, deriving from different monomers, but they may comprise some common repeating units or monomer units (copolymers).

The amphiphilic block copolymers may be linear, grafted, comb, crosslinked or star architecture.

A linear architecture would normally exclude crosslinked structures.

A star architecture generally requires a core radiating at least three functional groups. The functional groups of the core may be reacted to form a covalent bond with either block A or Block B. The formed arms containing block A or B are then further reacted to incorporate an alternating AB or BA structure depending upon which block forms the first sequence radiating off the core.

For purposes of the invention the term “polymer block” refers to one of the blocks of the block copolymer (either the hydrophilic block or the hydrophobic block).

Amphiphilic block copolymers are normally defined as block copolymers comprising hydrophobic and hydrophilic blocks or segments.

In the block copolymer of the invention, block A is hydrophilic and block B is hydrophobic. Hydrophilic or hydrophobic properties of a block refer to the property said block would have without the other block(s), that is the property of a polymer consisting of the same repeating units as said block and having the same average molecular weight.

The terms “hydrophobic” and “hydrophilic,” when applied to the block copolymers of this invention, are used in their ordinary sense. That is, hydrophilic, when it refers to a polymer, means that the polymer has a strong tendency to bond with or absorb water, which can result in solution of the polymer or swelling and/or formation of a gel. This property is characteristic of polymers prepared from polar or ionic monomers. Similarly, hydrophobic, when it refers to hydrophobic block, means that the polymer is antagonistic to water and generally cannot be dissolved in or swelled by water. This property is characteristic of polymers prepared from relatively non-polar monomers.

The hydrophobic block may be derived from monomers such as methyl methacrylate which are somewhat soluble in water. The important attribute of the hydrophobic block is once it is formed, the resulting block is insoluble or not swellable in water.

The formed amphiphilic block copolymer, may be soluble or dispersible in water. The amphiphilic block copolymer may for example be dispersible in water. The amphiphilic block copolymer may also form micelles.

Lower branched or unbranched alkyl of C₁ to C₄ is for example methyl, ethyl, propyl, isopropyl, n-butyl, isobutyl and sec-butyl.

C₁-C₄ alkylhydroxy for purposes of the invention means for example that a branched or unbranched alkyl chain may be substituted by an hydroxyl group. Examples include —CH₂CH₂OH, —CH₂CH₂CH₂OH and

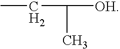

### R₃ and R₄ can be combined to form a ring containing one or more hetero atoms, for example pyrrolidine, imidazoline, piperidine, piperazine and morpholine.

Branched or unbranched C₁₋₂₂ alkyl means, for example, C₁-C₁₈, C₁-C₁₆, C₁-C₂₁, C₁-C₈, C₁-C₆, or preferably C₁-C₄-alkyl. Alternatively, C₁-C₂₂ alkyl may be C₄-C₂₂, C₆-C₂₂, C₈-C₂₂, C₁₀-C₂₂ or C₁₂-C₂₂. Examples are methyl, ethyl, propyl, isopropyl, n-butyl, sec-butyl, isobutyl, tert-butyl, pentyl, hexyl, heptyl, 2,4,4-trimethylpentyl, 2-ethylhexyl, octyl, nonyl, decyl, undecyl, dodecyl, tetradecyl, pentadecyl, hexadecyl, heptadecyl octadecyl, lauryl, stearyl, cetyl, behenyl or mixtures thereof. C₈-C₂₂ alkyl is for example, 2,4,4-trimethylpentyl, 2-ethylhexyl, octyl, nonyl, decyl, undecyl, dodecyl, tetradecyl, pentadecyl, hexadecyl, heptadecyl octadecyl, lauryl, stearyl, cetyl, behenyl or mixtures thereof.

Z⁻ may be a counterion, represented by but not limited to chloride, bromide, iodide, fluoride, substituted or unsubstituted aryl sulfonates, sulfate, alkyl sulfonates such as methyl sulfonate, ethyl sulfonate, carboxylates, nitrate, phosphates, tetrafluoroborate, tetraalkylborate, tetraarylborate, perchlorate, and hexafluorophosphate.

Cationic monomer units may be formed from potentially cationic monomers or cationic monomers. For example, additional cationic monomers or potentially cationic monomers may be quaternized N,N-dialkylaminoalkyl(meth)acrylate, quaternized N,N-dialkylaminoalkyl (meth)acrylamide or quaternized diallymethylamine.

The cationic monomer units comprising the hydrophilic block (A) are quaternized thus giving a permanent cationic charge to the block copolymer.

The corresponding amines of formula (I) and (II) may be alkylated to form the quaternary ammonium salt after formation of the hydrophilic polymeric block (A).

There are no particular limitations on the quaternizing agents that can be used to quaternize the tertiary amino groups of the hydrophilic block of the block copolymer. For example, the quaternizing agents may include alkyl halides such as methyl chloride, ethyl chloride, methyl bromide, ethyl bromide, methyl iodide, ethyl iodide and long chain alkyl halides such as C₆-C₂₄alkyl halides; alkyl halide carboxylates such as sodium chloroacetate, sodium bromoacetate, and sodium iodoacetate, benzyl halides such as benzyl chloride, benzyl bromide and benzyl iodide, sulfonic acid ester derivatives such as dimethyl sulfate, diethyl sulfate, methyl o-toluene sulfonate, methyl p-toluene sulfonate, ethyl o-toluene sulfonate, ethyl p-toluene sulfonate, methyl methane sulfonate, ethyl methane sulfonate, methyl benzene sulfonate and ethyl benzene sulfonate.

The hydrophilic polymer block (A) comprises monomer units of formula (I) or (II).

Representative examples of monomers which may form monomer units of formula (I) and (II) are

selected from the group consisting of dimethylaminoethyl acrylate,
dimethylaminoethylmethacrylate, dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl methacrylate methyl sulfate quaternary salt, dimethylaminoethyl methacrylate benzyl chloride quaternary salt, diethylaminoethyl acrylate, diethylaminoethyl methacrylate, diethylaminoethyl acrylate methyl chloride quaternary salt, diethylaminoethyl methacrylate methyl chloride quaternary salt, methacrylamidopropyldimethylamine,
methacrylamidopropyltrimethylammonium chloride, acrylamidopropyldimethylamine, acrylamidopropyltrimethylammonium chloride, dimethylaminopropylacrylamide methyl sulfate quaternary salt, diallylamine, diallymethylamine, diallydimethyl ammonium chloride, diallyldimethylammonium bromide, diallyldimethylammonium sulfate, diallydimethylammonium phosphate, diallyldi(beta-hydroxyethyl)ammonium chloride and diallylmethylbenzylammonium chloride.

The hydrophilic block and/or the hydrophobic block may or may not contain hydroxy groups. Both blocks contain monomer units absent any hydroxy groups.

While the hydrophilic A must contain a monomer unit of formula (I) or (II), the hydrophilic block (A) may also contain additional cationic, potentially cationic, anionic, potentially anionic, nonionic, zwitterionic monomer units or mixtures thereof.

Thus the hydrophilic block A for example may be a homopolymer or copolymer.

The formed hydrophilic block (A) polymer may carry an overall cationic charge. For example, the hydrophilic block will comprise cationic monomer units which are formed from a monomer selected from the group consisting of a monomer of formula (III), a monomer of formula (IV) and a vinyl or allylic nonionic monomer, or the hydrophilic (A) block will comprise cationic monomer units which are formed from a monomer selected from the group consisting of a monomer of formula (III), a monomer of formula (IV) and anionic monomers wherein the mole % of monomers defined by formula (III) and (IV) exceed the mole % of anionic monomer. Additional combinations for the hydrophilic block A polymer might be monomers units which are formed from a monomer selected from the group consisting of a monomer of formula (III), a monomer of formula (IV) and zwitterionic monomers.

For purposes of the invention (meth)acrylate includes acrylate and methacrylate derivatives.

Representative examples of additional cationic monomers may be selected from the group consisting of suitable cationically charged or potentially cationically charged monomers including dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, dimethylaminoethyl acrylate, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacrylate, diethylaminoethyl acrylate, diethylaminoethyl acrylate methyl chloride quaternary salt, diethylaminoethyl methacrylate, diethylaminoethyl methacrylate methyl chloride quaternary salt, methacrylamidopropyltrimethylammonium chloride, acrylamidopropyltrimethylammonium chloride, dimethylaminopropylacrylamide methyl sulfate quaternary salt, dimethylaminopropylacrylamide sulfuric acid salt, dimethylaminopropylacrylamide hydrochloric acid salt, dimethylaminopropylacrylamide, diallylalkylamine and vinylpyridine.

The nonionic monomer(s) are polymerizable allylic or vinylic compounds and are electrically neutral. Representative nonionic monomers include acrylamide, methacrylamide, N-methyl(meth)acrylamide, N,N-diimethyl(meth)acrylamide, N-isopropyl(meth)acrylamide, N-(2-hydroxypropyl)(meth)acrylamide, poly(ethylene glycol)(meth)acrylate, poly(ethylene glycol) monomethyl ether mono(meth)acrylate, N-methylolacrylamide, N-vinylformamide, N-vinylacetamide, N-vinyl-N-methylacetamide, fumaramide, N-vinyl-2-pyrrolidone, glycerol mono((meth)acrylate), 2-hydroxyethyl(meth)acrylate, vinyl methylsulfone, vinyl acetate, diacetone acrylamide, diesters of maleic, fumaric, succinic and itaconic acids.

Nonionic monomers may be macromers which contain vinylic or allylic functionality. Macromers may be defined as a polymer containing a terminal allylic, vinylic or ethylenically unsaturated end group. For example, poly(ethylene glycol)(meth)acrylate, poly(ethylene glycol) monomethyl ether mono(meth)acrylate are macromers.

The hydrophilic block (A) may also comprise monomer units formed from nonionic hydrophilic monomers such as acrylamide or poly(ethylene glycol)(meth)acrylate, poly (ethylene glycol) monomethyl ether mono(meth)acrylate macromers.

Thus the amphiphilic block copolymer may contain a hydrophilic block A which is a copolymer and additionally comprises alkylene glycol units.

The weight % of the hydrophilic nonionic monomers which may form the hydrophilic block A may range from about 0 to about 30 mole % of the total weight of polymer block A, about 1 to about 20 mole %, about 1 to about 10 mole % or about 1 to about 5 weight % of the total weight of polymer block A.

Hydrophobic nonionic monomers may also be incorporated into the hydrophilic block A and include acrylates such as methyl(meth)acrylate, ethyl(meth)acrylate, hexyl(meth)acrylcate, hexyl(meth)acrylate, octyl(meth)acrylate, stearyl(meth)acrylate, stearyl ethoxy(meth)acrylate stearyl ethoxyallylether and mixtures thereof.

Although hydrophobic nonionic monomers may be included in the hydrophilic block A, the block A should still maintain is hydrophilic character. Thus the weight % of the monomer units of formula (I) and/or formula (II) will exceed the weight % of nonionic hydrophobic monomers in the polymer block A. For example, the weight % of the hydrophobic nonionic monomers in the hydrophilic block A may range from about 0 to about 30 mole % of the total weight of polymer block A, about 1 to about 20 mole %, about 1 to about 10 mole % or about 1 to about 5 weight % of the total weight of polymer block (A). Preferably, there are no hydrophobic monomers incorporated into hydrophilic block (A).

The anionic or potentially anionic monomer units may be formed from anionic or potentially anionic monomer(s). The anionic or potentially anionic monomer(s) are derived from alpha ethylenically unsaturated monomers selected from the groups consisting of alpha ethylenically unsaturated monomers containing phosphate or phosphonate groups, alpha ethylenically unsaturated monocarboxylic acids, monoalkylesters of alpha ethylenically unsaturated dicarboxylic acids, monoalkylamides of alpha ethylenically unsaturated dicarboxylic acids, alpha ethylenically unsaturated compounds comprising a sulphonic acid group, salts of alpha ethylenically unsaturated compounds comprising a sulphonic acid group and mixtures thereof.

Representative examples of anionic or potentially anionic monomers include acrylic acid, methacrylic acid, vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid, 2-sulphoethyl methacrylate, salts of 2-sulphoethyl methacrylate, acrylamido-2-methylpropanesulphonic acid (AMPS), salts of acrylamido-2-methylpropanesulphonic acid, maleic acid, fumaric acid, itaconic acid, succinic acid, styrenesulphonate and its salts or mixtures thereof.

The zwitterionic monomer or monomers are derived from ethylenically unsaturated monomer or monomers. A zwitterionic monomer for the purposes of the invention is defined as a monomer that contains both anionic and cationic charges or potential anionic and cationic charges.

Representative examples are
N,N-dimethyl-N-acryloyloxyethyl-N-(3-sulfopropyl)-ammonium betaine,
N,N-dimethyl-N-acryloyloxyethyl-N-(2-carboxymethyl)-ammonium betaine,
N,N-dimethyl-N-acrylamidopropyl-N-(3-sulfopropyl)-ammonium betaine,
N,N-dimethyl-N-acrylamidopropyl-N-(2-carboxymethyl)-ammonium betaine,
2-(methylthio)ethyl methacryloyl-S-(sulfopropyl)-sulfonium betaine,
2-[(2-acryloylethyl)dimethylammonio]ethyl 2-methyl phosphate,
2-(acryloyloxyethyl)-2′(trimethylammonim)ethyl phosphate,
[(2-acryloxylethyl)dimethylammonio]methyl phosphonic acid,
2-methacryloyloxyethyl phosphorylcholine (MPC),
2-[(3-acrylamidopropyl)dimethylammonio]ethyl 2′-isopropyl phosphate (AAPI),
1-vinyl-3-(3-sulfopropyl)imidazolium hydroxide,
(2-acryloxyethyl)carboxymethyl methylsulfonium chloride,
1-(3-sulfoproyl)-2-vinylpyridinium betaine,
N-(4-sulfobutyl)-N-methyl-N,N-diallylamine ammonium betaine (MDABS),
N,N-diallyl-N-methyl-N-(2-sulfoethyl) ammonium betaine or mixtures thereof.

The hydrophilic polymer block (A) may be a homopolymer or random copolymer, block copolymer or a grafted polymer or copolymer.

The hydrophilic block (A) may be formed entirely of vinyl or allylic cationic monomers. The hydrophilic block (A) for example, contains no pendant hydroxyl groups. The cationic charge on the hydrophilic block is preferably permanent. Thus, for example, the cationic monomers or potentially cationic monomers forming the hydrophilic block will be quaternized.

The average molecular weight of the hydrophilic polymer block (A) will vary from about 200 g/mole to about 1,000,000 g/mole, about 200 g/mole to about 500,000 g/mole, about 200 g/mole to about 50,000 g/mole, and more preferably from about 200 g/mole to 100,000 g/mole, for example, about 200 g/mole to about 10,000 g/mole, about 200 to about 5,000 or about 200 to about 3000 or about.

### Hydrophobic Block (B)

Hydrophobic block (B) is formed from an ethylenically unsaturated hydrophobic monomer.

Ethylenically unsaturated hydrophobic monomers include olefinic monomers selected from the group consisting of ethylene, propylene, 1-butene, 2-methyl-1-butene, 2-butene, isobutylene, butadiene, isoprene, pentene, 4-methyl-1-pentene, 1-hexene, 1-octene, 1-decene, 1-octadecene, vinyl cyclohexene, cyclopentadiene, β-pinene, styrene, alpha-methyl styrene, p-chlorostyrene, p-methyl styrene, vinyl chloride and mixtures thereof.

Ethylenically unsaturated vinyl hydrophobic monomers are also included under the term ethylenically unsaturated monomers. The ethylenically unsaturated vinyl hydrophobic monomers may be branched or unbranched C₁-C₂₂ (meth)acrylates, branched or unbranched C₁-C₂₂ (meth)acrylamides. For example, the hydrophobic monomers may be selected from the group consisting of methyl(meth)acrylate, ethyl(meth)acrylate, propyl(meth)acrylate, butyl(meth)acrylate, pentyl(meth)acrylate, 2-ethylhexyl (meth)acrylate, octyl(meth)acrylate, lauryl(meth)acrylate, stearyl(meth)acrylate, cetyl (meth)acrylate, behenyl(meth)acrylate, methyl(meth)acrylamide, ethyl (meth)acrylamide, propyl(meth)acrylate, butyl(meth)acrylamide, pentyl (meth)acrylamide, hexyl(meth)acrylamide, 2-ethylhexyl(meth)acrylamide, octyl(meth)acrylamide, lauryl(meth)acrylamide, stearyl(meth)acrylamide, cetyl (meth)acrylamide, behenyl(meth)acrylamide and mixtures thereof.

The hydrophobic polymer block (B) is for example formed from an olefinic monomer listed above or an ethylenically unsaturated vinyl monomer (formula III below) wherein the ethylenically unsaturated vinyl monomer is selected from the group consisting of branched or unbranched C₄-C₂₂ alkyl(meth)acrylates, C₄-C₂₂ alkyl N substituted (meth)acrylamides, C₆-C₂₂ alkyl(meth)acrylates or C₆-C₂₂ alkyl N substituted (meth)acrylamides, C₈-C₂₂ alkyl(meth)acrylates or C₈-C₂₂ alkyl N substituted (meth)acrylamides and C₁₀-C₂₂ alkyl(meth)acrylates or C₁₀-C₂₂ alkyl N substituted (meth)acrylamide. The nitrogen of the (meth)acrylamide may be mono or di alkyl substituted.

Formula (V) is defined as

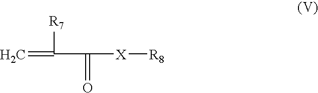

where R₇ is hydrogen or methyl, and R₈ is a branched or unbranched C₁₋₂₂ alkyl, aryl or benzyl, and X is oxygen or —NR₁, wherein R₁ is as defined above.

Branched or unbranched C₁₋₂₂ alkyl is defined as above.

The hydrophobic polymer blocks may be any molecular weight. The preferred molecular weight however will vary from 200 g/mole to about 1,000,000 g/mole, about 200 g/mole to about 500,000 g/mole, about 200 g/mole to about 50,000 g/mole and more preferably from 200 g/mole to about 10,000 g/mole, or about 200 g/mole to about 5,000 g/mole.

The hydrophobic polymer block may be a homopolymer or random copolymer, block copolymer or a grafted polymer or copolymer. Thus for example, the hydrophobic polymer block may be formed from a linear copolymer of ethylene and butylene.

The hydrophobic block (B) may also contain additional cationic, potentially cationic, anionic, potentially anionic, nonionic, zwitterionic monomer units or mixtures thereof.

These additional cationic, potentially cationic, anionic, potentially anionic, nonionic, zwitterionic monomers are defined as above under the hydrophilic block (A).

Although the hydrophobic block (B) may contain additional hydrophilic monomers, hydrophobic block B should maintain its hydrophobic properties. Thus the hydrophobic block (B) may be a copolymer.

The olefinic or ethylenically unsaturated vinyl monomer units making up the hydrophobic block (B) may normally exceed cationic, anionic, nonionic hydrophilic (different than the olefins listed above) or zwitterionic monomer units. For example, the weight % of hydrophilic nonionic monomers in the hydrophobic block (B) may range from about 0 to about 30 weight % of the total weight of polymer block (B), about 1 to about 20 weight %, about 1 to about 10 weight % or about 1 to about 5 weight % of the total weight of polymer block (B). For example, the weight % of the hydrophilic nonionic monomers in hydrophobic block (B) may be 0 weight %.

The hydrophobic block (B) will preferable be uncharged or neutral. This means that the hydrophobic block (B) will preferably be formed from ethylenically unsaturated monomers which are not charged and exclude cationic, anionic or zwitterionic monomers.

The hydrophobic block (B) may be formed from less than 30 wt. %, 20 wt. % or less, or 10 wt. % or less hydrophilic monomers based on the total weight of the polymer block (B).

The hydrophobic polymer block may be a homopolymer or random copolymer, block copolymer or a grafted polymer or copolymer.

### Preparation of the Amphiphilic Block Copolymer

The hydrophilic block (A) and the hydrophobic block (B) may be made separately and then covalently linked to form the amphiphilic block copolymer.

The amphiphilic block copolymers may also be formed by living polymerization methods well known in the art. For example, atom transfer radical polymerization (ATRP). ATRP is well known and disclosed in U.S. Pat. Nos. 6,512,060, 6,407,187, 5,763,548 and 5,807,937 herein incorporated entirely by reference. According to this method initiators are employed which generate a radical atom, such as a halide radical in the presence of a redox system of transition metals of different oxidation states, e.g. Cu(I) and Cu(II), providing “living” or controlled radical polymerization.

Specific initiators are selected from the group consisting of α,α′-dichloro- or α,α′-dibromoxylene, p-toluenesulfonylchloride (PTS), hexakis-(α-chloro- or α-bromomethyl)-benzene, 2-chloro- or 2-bromopropionic acid, 2-chloro- or 2-bromoisobutyric acid, 1-phenethyl chloride or bromide, methyl or ethyl 2-chloro- or 2-bromopropionate, ethyl-2-bromo- or ethyl-2-chloroisobutyrate, chloro- or bromoacetonitrile, 2-chloro- or 2-bromopropionitrile, α-bromo-benzacetonitrile and α-bromo-.gamma.-butyrolactone (=2-bromo-dihydro-2(3H)-furanone).

An alternative and more direct method for forming the amphiphilic block copolymer is described in example 4 of the present disclosure.

The method for preparing the amphiphilic block copolymer above comprises the steps of

polymerizing a cationic monomer of formula (III) or (IV)
and
in the presence of an hydrophobic (B) block polymer, which hydrophobic (B) block is terminated with a functional group or chain transfer group.

The hydrophobic (B) block terminated with a functional group or chain transfer group is for example disclosed in U.S. Pat. No. 6,552,131, herein incorporated entirely by reference. This reference describes low molecular-weight polyolefins obtained by thermal degradation. The so obtained polyolefins contain, on an average, 1 to 1.5 terminal double bonds per molecule. These terminally unsaturated polyolefins may be modified to further functionalize the unsaturated ends.

End functionalized polyolefins may also be purchased directly from suppliers such as Scientific Polymer Products, Mitsui Chemicals, Baker Petrolite and Aldrich. For example, copolymers of ethylene and butylene, copolymers of ethylene, butylene and propylene and homopolymers of styrene which are mono or dihydroxy terminated are commercially available from Scientific Polymer Products in a range of average molecular weights (1,700-4,200). Polyethylene mono-ol is available from Baker Petrolite at Mₙ˜700. Poly (ethylene-co-1,2-butylene mono-ol is available from Aldrich, CAS no. 68954-09-6, Mₙ ˜3750.

A thiol terminated hydrophobic block may be synthesized by treating for example, a hydrophobic resin having double bonds or hydroxyl groups at its terminals with such reagents as thioacetic acid, thiobenzoic acid, thiopropionic acid, thiobutyric acid, secondary alcohol or thiovaleric. The synthesis is well known to those skilled in the art, for example in Japanese Patent No. 3481733 and Ying Jun Du et al. in J. Appli. Polym. Sci., 2003, 594.

One of the advantages of the above method is the ability to directly polymerize a cationic monomer in the presence of the hydrophobic block polymer terminated with a chain transfer agent thus arriving at the charged amphiphilic block copolymer directly.

Suitably terminated with a chain transfer group for purposes of the invention means termination or pendant termination with a thiol, xanthate, dithioester, trithioester, dithiocarbamate, secondary alcohol or nitroxyl.

The block copolymer may then be directly formed by polymerizing the cationically charged vinyl or allylic monomer in the presence of for example, a thiol terminated hydrophobic block. The polymerization of the cationically charged vinyl or allylic monomer may be done in the presence of an initiator.

Thus the hydrophilic block (A) and hydrophobic block (B) for example, are then covalently linked via a sulfur atom to form the amphiphilic block copolymer.

When the chain transfer agent is sulfur, and the monomer is cationic, the resulting amphiphilic block copolymer is defined for example, by the formula (VI) or (VII) below.

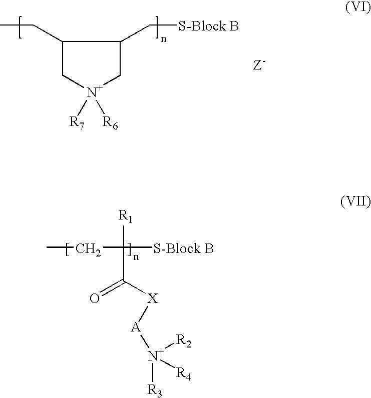

wherein R₁, R₂, n and Z⁻ are defined as above in formula (II) and n is at least 2.

### S is sulfur and

### Block (B) is a hydrophobic block and may represent a polyolefin or formed from ethylenically unsaturated hydrophobic monomers.

It is also possible that the hydrophobic block be grafted with pendent chain transfer groups such as thiols. The cationic monomer, for example diallyldialkylammonium salt, would then be polymerized in the presence of a hydrophobic polymer with thiol pendant groups, giving a grafted block copolymer.

Thus a hydrophobic block (B) might be grafted with a cationic block (A) to form a comb architecture amphiphilic block copolymer.

Polymerization may be initiated with an polymerization initiator such as those activated by heat, light or electromagnetic radiation.

Typical initiators are for example radical initiators such as azobis compounds such as azobisisobutyronitrile, azobis-2,4-dimethylvaleronitrile, azobiscyclohexane carbonitrile, azobis-2-amidinopropane hydrochloride, dimethyl azobisisobutyrate, azobisisobutylamidine hydrochloride and 4,4′-azobis-4-cyanovaleric acid, peroxide initiators such as benzoyl peroxide, benzoyl 2,4-dichloroperoxide, di-tert-butyl peroxide, lauroyl peroxide, acetyl peroxide, diisopropyl dicarbonate peroxide, cumene hydroperoxide, tert-butyl hydroperoxide, dicumyl peroxide, p-menthane hydroperoxide, pinane hydroperoxide, methyl ethyl ketone peroxide, cyclohexanone peroxide, diisopropyl peroxy dicarbonate, tert-butyl peroxy laurate, di-tert-butyl peroxy phthalate, dibenzyl oxide and 2,5-dimethylhexane-2,5-dihydroperoxide, and redox initiators such as benzoyl peroxide-N,N-dimethyl aniline, peroxodisulfuric acid-sodium hydrogen sulfite and salts of persulfate such as sodium, potassium or ammonium persulfate.

Photoinitiators are also envisioned.

The reaction solvent includes, for example, aliphatic hydrocarbons such as pentane, hexane, heptane, octane, decane, dodecane and tetradecane, alicyclic hydrocarbons such as cyclopentane, methylcyclopentane, cyclohexane, methylcyclohexane, cyclooctane and cyclohexene, aromatic hydrocarbons such as benzene, toluene and xylene, halogenated hydrocarbons such as dichloromethane, chloroform, dichloroethane, dichloropropane, trichloroethylene, chlorobenzene, dichlorobenzene and 2,4-dichlorotoluene, esters such as methyl acetate, ethyl acetate and butyl acetate, ketones such as acetone and methyl ethyl ketone, and dioxane, tetrahydrofuran, acetonitrile, dimethylformamide, dimethyl sulfoxide and alcohols such as, ethanol, propanol, n-butanol and sec-butanol.

The addition of surfactants to the solvents is also envisioned.

These can be used alone or as a mixture thereof. Mixtures of solvents may be preferable when the blocks are dissimilar. Such solvents preferably include C₂-C₆ alcohols, and/or N,N-dimethylformamide, dimethylsulfoxide, or N′N-dimethylacetamide, and may be combined with other solvents, such as toluene or tetrahydrofuran.

C₂-C₆ alcohols are for examples, n-propanol, n-butanol, sec-butanol, cyclopentanol, n-pentanol, hexanol and cyclohexanol.

The hydrophobic block will to a large extent determine the choice of solvent. For example, if the polyolefin (Block B) is polystyrene, N,N-dimethylformamide may be used to disperse the polystyrene block. The diallydialkylammonium salt monomer may be dispersed in a C₂-C₆ alcohol and then added to the dispersed polystyrene and polymerized to form the amphiphilic block copolymer.

If the reaction is run in a solvent system, it is important the solvent system allow good dispersion of both the hydrophobic block and the forming hydrophilic block. The particular solvent system will depend very much on the composition and molecular weight of each block and needs to be determined experimentally.

Water based systems incorporating a surfactant might also be used for synthesis of the block copolymer.

### Applications of the Amphiphilic Block Copolymer

The amphiphilic block copolymer comprising the hydrophilic polymer block (A) and the hydrophobic block (B) is such that the formed amphiphilic block copolymer may be dispersed in an aqueous medium in the presence of surfactants.

Treatment of a hydrophobic substrate with an aqueous dispersion of the block copolymer increases the hydrophilicity or wettability of the substrate.

As used herein, the term “hydrophobic substrate” is meant to include any shaped article, provided it is composed, in whole or in part, of a hydrophobic surface. The hydrophobic surface may be porous or nonporous. For example, the substrate may be a sheet-like material, such as a sheet of a foamed material. The sheet-like material also may be a fibrous web, such as a woven or non-woven fabric or web. The substrate also may be a hydrophobic polymer fiber, per se, or hydrophobic polymer fibers which have been formed into a fibrous web. The fibrous web desirably will be a non-woven web, such as, but not limited to, a meltblown web, a spunbonded web, a carded web or an airlaid web. The substrate also may be a laminate of two or more layers of a sheet-like material. For example, the layers may be independently selected from the group consisting of meltblown webs and spunbonded webs. However, other sheet-like materials such as films or foams may be used in addition to, or instead of, meltblown and spunbonded webs. In addition, the layers of the laminate may be prepared from the same hydrophobic polymer or different hydrophobic polymers.

The hydrophobic substrate includes hydrophobic plastics or hydrophobic non-wovens that may include natural fibers as well as synthetic fibers. According to one desirable embodiment of the present invention, the fibers of the substrate are substantially uniformly coated with a hydrophilic treatment. As an example, a non-woven fabric made from hydrophobic synthetic fibers, such as polyolefin fibers, is treated by the method of the invention with a composition comprising the amphiphilic block copolymer to provide a wettable, polyolefin non-woven fabric. The polyolefin fibers that form the fabric may include polyethylene and/or polypropylene fibers and fibers produced from compositions and blends that include a polyethylene and/or a polypropylene resin and can be produced by various known methods.

The hydrophobic substrate material may be a non-woven formed from polyesters such as poly(ethylene terephthatalate) or polyolefins such as polypropylene.

The term “polyolefin” is used herein to mean a polymer prepared by the addition polymerization of one or more unsaturated monomers which contain only carbon and hydrogen atoms. Examples of such polyolefins include polyethylene, polypropylene, poly(1-butene), poly(2-butene), poly(1-pentene), poly(2-pentene), poly(3-methyl-1-pentene), poly(4-methyl-1-pentene), and so forth. In addition, such term is meant to include blends of two or more polyolefins and random and block copolymers prepared from two or more different unsaturated monomers. Because of their commercial importance, the most desired polyolefins are polyethylene and polypropylene. The polyolefin may contain additives as is known or customary in the art. For example, the polyolefin may contain pigments, opacifiers, fillers, delustrants, antioxidants, antistatic agents, stabilizers, oxygen scavengers, and so forth.

Preferred hydrophobic plastic materials are exemplified by but not limited to polyethylene, polypropylene, polystyrene, polymethylmethacrylate, polyvinyl chloride and polycarbonate.

The block copolymer coating described herein can also be applied to many types of hard surfaces, including, but not limited to fiberglass and plastics. Fiberglass surfaces comprise resins, polymers, reinforcing fabric and fibers. Hard surfaces made from fiberglass include but are not limited to bathtubs, boats, motorcycles, car bodies, canoes, airplanes, model aircraft, jet skis, sculptures, as well as traditional industrial molding and model-making articles.

There are several basic types of hard surface plastics which include polyalkylene terephthalate, polyethylene terephthalate, high density polyethylene, polyvinyl chloride, low density polyethylene, polypropylene, polymethylmethacrylate (plexiglass), polycarbonate, polystyrene, TEFLON, melamine polymers and mixtures thereof. These types of plastics may also be combined with other materials including, but not limited to nanoparticles, to make all sorts of composites. Carbon and graphite fibers are high-strength materials that are used as reinforcing agents in plastic composites.

A suitable measure for assessing the hydrophilic/hydrophobic nature of a substrate is the contact angle of water on the respective surface. The term hydrophobic surfaces is usually used here if the contact angle of water is above 90 degree.

The use of the block copolymer of the invention brings about a reduction in the contact angle by at least 5 degrees, by at least 10 degrees and especially at least 15 degrees compared with that of the unmodified hydrophobic substrate.

Surprisingly, the treatment of the hydrophobic substrates with aqueous dispersions of the amphiphilic block copolymers of this invention may decrease the contact angle by as much as or more than 10, 15 or 20 degrees.

The concentration of the amphiphilic block copolymers of the invention in the aqueous dispersions is typically about 0.01 wt. % to about 5.0 wt. %, preferably the concentration is about 0.01 wt. % to about 2.0 wt. %, for example, 0.01 wt. % to about 1.0 wt. % based on the total weight of the aqueous dispersion.

The polymers used in the present invention may be incorporated into any type of cleaning formulation that is known to those skilled in the art. The polymer may be present in the cleaning formulation in an amount ranging from 0.01% to 20%, or preferably from 0.05% to 5% and more preferably from 0.1% to 2% by weight. The cleaning formulation may also contain water, surfactants, solvents, builders, thickeners, dyes, perfumes, salts, hydrotropes, biocides, fungicides and the like. The cleaning formulation may also contain other types of soil release polymers, colorants, preservatives, antimicrobials, optical brighteners, ultraviolet light absorbers, other light management agents, ionization agents, antifoam agents, enzymes, bleaching agents, oxidation catalysts, zeolites, and/or odor suppressing agents including but not limited to cyclodextrin and derivatives thereof, or mixtures thereof.

The surfactants used in the surface cleaner formulation are typically water-soluble or water dispersible. The surfactants are well known in the art.

Surfactants used in the present invention may be selected from one or more surfactants, which may be anionic, cationic, non-ionic, amphoteric or zwitterionic surface-active agents. Most preferred in this invention are the cationic and nonionic surfactants, because the cationic nature of the polymer may be incompatible with certain anionic surfactants.

Nonionic surfactants that may be used in the present invention include but are not limited to alkoxylated alcohols, including ethoxylated and propoxylated alcohols, as well as ethoxylated and propoxylated alkyl phenols. Other classes include sorbitan fatty esters and fatty acids of unsaturated alcohols.

Other classes of non-ionic surfactants include alkylpolysaccharides as disclosed in U.S. Pat. No. 4,565,647, which have a hydrophobic group containing from about 6 to 30 carbon atoms, preferably from about 10 to 16 carbon atoms as well as a polysaccharide, such as a polyglycoside, hydrophilic group.

Another class of suitable surfactants comprises certain mono-long chain-alkyl cationic surfactants for use in hard surface cleaning compositions according to the invention. Cationic surfactants of this type include quaternary ammonium salts of the general formula R¹⁰R₂₀R₃₀R₄₀N⁺X⁻ wherein the R groups are long or short hydrocarbon chains, typically alkyl, hydroxyalkyl or ethoxylated alkyl groups, and X is a counter-ion (for example, compounds in which R₁₀ is a C₈-C₂₂ alkyl group, preferably a C₈-C₁₀ or C₁₂-C₁₄ alkyl group, R₂₀ is a methyl group, and R₃₀ and R₄₀, which may be the same or different, are methyl or hydroxyethyl groups); and cationic esters (for example, choline esters). X is preferably a halide counter-ion, for example chloride or bromide.

The cleaning formulation may be applied as a ready-to-use spray, liquid or paste, directly on the surface, which is then wiped using a paper towel, sponge, cloth, mop or other suitable wiping implement. Alternatively the composition may be applied first to the wiping implement and then to the surface. The composition may also be supplied in a dilutable form that is a solid or liquid concentrate that may be diluted with water to arrive at the final cleaning composition. For example it may be in the form of a dilutable powdered or granular formulation, or a tablet, pouch or sachet.

The composition may be added to a wipe or pad, either reusable or disposable, which is then used to treat the surface by wiping. The composition is absorbed into or adsorbed onto the wipe or pad, that is to say, the wipe or pad is impregnated with the aqueous cleaning composition. Such a wipe may be constructed of natural or synthetic fibers, for example cellulosic, polyester, polyolefin, woven or non-woven fibers, or any other material or combination of materials suitable for making a wiping cloth as is known by those skilled in the art. Such wiping cloths typically are constructed out of non-woven type materials. Polyolefin is for example polypropylene or polypropylene copolymers or blends. Cellulosic means cellulose-based.

The composition containing the polymer in a cleaning formulation will typically gives a pH of 3 to 12, preferably from 4 to 11.

The invention further relates to a method of hard surface cleaning, which comprises contacting a surface with an effective amount of a cleaning formulation according to the invention.

In one such method, the cleaning formulation according to the invention is sprayed onto a soiled hard surface. The wetted surface is then wiped clean using a paper towel or other suitable applicator tool.

In an alternative method of application, the cleaning formulation of the invention can be applied to a clean surface as a pre-treatment step, causing the polymer to adhere to the surface. The applied hydrophilic properties of the treatment will lead to certain cleaning benefits like reduced spotting and faster wetting. Additionally the block copolymers of the invention are stable to water rinsing. Thus benefits of the block copolymers are preserved in wet environments.

Substrates benefiting from treatment with the composition of the invention include, but are not limited to, fabric, textiles, plastics, carpets, non-wovens, and other substrates which may benefit from improving the wettability of the surface.

While the block copolymers of the present invention are very useful in a variety of coating applications, their usefulness extends beyond conventional coatings. These include end-uses such as improving wetting properties of fibers, textiles, carpets or non-wovens in order to improve their dyeability or printability.

Thus the invention is directed to a method of improving the dyeability or printability of a textile, carpet or fabric wherein the textile, carpet or fabric is treated with a block copolymer described above. Preferably the textile, carpet or fabric is coated with an aqueous formulation of the block copolymer with a surfactant.

The fabric may be formed from synthetic hydrophobic fibers. Examples of hydrophobic fibers include nylon, polyolefins such as polypropylene, polyesters such as polyalkylene terephthalates, for example, polyethylene terephthalate or polybutylene terephthalate, nylon, and polyacrylonitrile.

The carpet may be formed from synthetic hydrophobic fibers. Examples of hydrophobic fibers include polyamides or nylon, polyolefins, especially polypropylene.

### EXAMPLES

All percents in the examples are based on total weight and molecular weight values are average molecular weights.

### Example 1

### Synthesis of Block Polymer of Ethylene-co-Butylene and Methacryloyloxyethyl Trimethylammonium Chloride

Poly(ethylene-co-butylene) mono-ol (Aldrich, Mₙ˜3800.92 g) was dissolved in 300 mL tetrahydrofuran (THF) and is kept on molecular sieves for 24 h. A 3-neck flask equipped with a magnetic stirring bar and a dropping funnel is purged with nitrogen and charged with the THF solution. Pyridine (11 mL) is added. The dropping funnel is charged with 2-bromomethylpropionyl bromide (7.4 mL) and 50 mL dry THF. This mixture is added into the flask dropwise. The mixture is stirred at room temperature for 24 h. The mixture is filtered and precipitated with methanol. The product is rinsed with methanol and dried in vacuum. This macroinitiator is charged into a flask with 1.75 g copper(I) bromide. The flask is evacuated and refilled with nitrogen four times. 50 mL THF sparged with nitrogen for 1 h is added. After the macroinitiator is dissolved, pentamethyldiethylenetriamine (2.6 mL) sparged with nitrogen for 1 h is added, followed by dimethylaminoethyl methacrylate (52 mL, also sparged with nitrogen for 1 h prior to addition). The mixture is sparged with nitrogen for 10 minutes, then is immersed in an oil bath set at 60° C. and stirred for 6 h under nitrogen. The reaction is quenched by placing the flask in an ice bath and diluting the mixture with THF (150 mL). The mixture is treated with a solution of 2.5 g tetra sodium ethylenediaminetetraacetic acid (Na₄EDTA) in 60 mL water. The solvent is stripped off and the water is removed by azeotropic distillation with isopropanol. The product is redissolved in THF, filtered and run through basic alumina. After evaporation of the solvent, a block copolymer is obtained. The Mₙ of the cationic block is 1700 according to ¹H NMR analysis.

This block copolymer (41 g) is dissolved in 50 mL chloroform and transferred into a 100-mL Schlenk tube with 30 mL chloroform. The mixture is cooled in a dry ice/isopropanol bath and 8.9 g methyl chloride is condensed into the tube. The mixture is allowed to warm to room temperature and allowed to stand for 3 days, then heated at 60° C. for 3 h. The tubes are opened to the atmosphere through an ethylene diamine trap. The solvent is evaporated, and the product is rinsed with ethyl acetate and dried in vacuum.

### Example 2

### Synthesis of Block Polymer of Ethylene-co-Butylene and Methacryloyloxyethyl Trimethylammonium Chloride

Poly(ethylene-co-butylene) mono-ol (Aldrich, Mₙ˜3800.83 g) is dissolved in 300 mL THF and kept on molecular sieves overnight. The solution is filtered into a 3-neck flask equipped with a magnetic stirring bar and a dropping funnel after it being purged with nitrogen. Pyridine (10 mL) is added. The dropping funnel is charged with 2-bromomethylpropionyl bromide (6.7 mL) and 67 mL dry THF. This mixture is added into the flask dropwise. The mixture is stirred at room temperature for 24 h. The mixture is filtered and precipitated with 400 mL methanol. The product is rinsed with methanol and dried in vacuum. 44.75 g of this macroinitiator is charged into a flask with 853 mg copper(I) bromide. The flask is evacuated and refilled with nitrogen four times. 25.3 mL THF sparged with nitrogen for 1 h is added. After the macroinitiator had dissolved, pentamethyldiethylenetriamine (1.26 mL) sparged with nitrogen for 1 h is added, followed by dimethylaminoethyl methacrylate (50.6 mL, also sparged with nitrogen for 1 h prior to addition). The mixture is sparged with nitrogen for 10 minutes, then immersed in an oil bath set at 60° C. and stirred at this temperature for 6 h under nitrogen. The reaction is quenched by placing the flask in an ice bath and diluting the mixture with THF (50 mL). The mixture is treated with a solution of 2.5 g Na₄EDTA in 60 mL water. The solvent is stripped off and the water is removed by azeotropic distillation with isopropanol. The product is redissolved in THF, filtered and run through basic alumina, then treated with Na₄EDTA solution again. After evaporation of the solvent, a block copolymer is obtained. The Mₙ for the cationic block is 3600 according to ¹H NMR analysis. The block copolymer is dissolved in 127 g dimethylformamide (DMF) and transferred into a Schlenk tube. 29.14 g methyl chloride is condensed into the tube and allowed to stand for 20 h. The product is precipitated with ethyl acetate and dried in vacuum.

### Example 3

### Block Copolymer of Lauryl Acrylate and Methacryloyloxyethyl Trimethylammonium Chloride

A mixture of 5.1 mL dimethylaminoethyl methacrylate, 52 mg cyanopropyl dithiobenzoate, 1.0 mL toluene and 3.8 mg azobis(isobutyronitrile) (AIBN) is sparged with N₂ for 30 min, then heated at 70° C. for 51 h. The product is purified by precipitation with hexane and dried in vacuum. The product is dissolved in 1.0 mL toluene and 5.3 mL lauryl acrylate and 3.8 mg AIBN is added. The mixture is sparged with N₂ for 1 h, then heated at 70° C. for 48 h. The product has a Mₙ of 25000. The product is dissolved in 30 mL methanol and transferred into a Shlenk tube. 2.73 g methyl chloride is condensed into the solution and the mixture is allowed to stand overnight. The product is precipitated with ethyl acetate and dried in vacuum.

### Example 4

### Block Copolymer of Ethylene-co-Butylene and Diallyldimethylammonium Chloride

To a solution of 55 g poly(ethylene-co-butylene) mono-ol Scientific Polymer Products, ˜3800 Mₙ) in 80 mL toluene is added 3.0 mL mercaptoacetic acid and 2 drops of cc. sulfuric acid. The mixture is sparged with N₂ for 30 min, and refluxed for 2 h. The product is precipitated with methanol and dried in vacuum. A solution of 22.5 g of this thiol is combined with a dispersion of 45 g diallyidimethylammonium chloride in 56 mL n-butanol and 1.125 g 2,2′-azobis(2-amidinopropane)dihydrochloride initiator. The mixture is sparged with N₂ for 3 h, and heated at 70° C. for 48 h. The product is precipitated with acetone and dried in vacuum. The product is treated with 1000 mL THF and centrifuged. The insoluble fraction is dried in vacuum

### Example 5

### Block Copolymer of Styrene and Methacryloyloxyethyl Trimethylammonium Chloride

A mixture of 5.1 mL dimethylaminoethyl methacrylate, 52 mg cyanopropyl dithiobenzoate, 1.0 mL toluene and 3.8 mg AIBN is sparged with N₂ for 30 min, then heated at 70° C. for 51 h. The product is purified by precipitation with hexane and dried in vacuum. The product is dissolved in 1.0 mL toluene and 2.2 mL styrene and 3.8 mg AIBN are added. The mixture is sparged with N₂ for 1 h, then heated at 70° C. for 48 h. The product has a Mₙ of 14100. The product is dissolved in 25 mL methanol and transferred into a Shlenk tube. 9.34 g methyl chloride is condensed into the solution and the mixture is allowed to stand overnight. The product is precipitated with ethyl acetate and dried in vacuum.

### Example 6

### Block Copolymer of Ethylene-co-Butylene and Methacryloyloxyethyl Trimethylammonium Chloride

To a solution of 55 g poly(ethylene-co-butylene) mono-ol Scientific Polymer Products, ˜3800 Mₙ) in 80 mL toluene is added 3.0 mL mercaptoacetic acid and 2 drops of cc. sulfuric acid. The mixture is sparged with N₂ for 30 min, and refluxed for 2 h. The product is precipitated with methanol and dried in vacuum. A solution of 22.5 g of this thiol is combined with a dispersion of 41 g methacryloyloxyethyl trimethylammonium chloride in 56 mL n-butanol and 1.125 g 2,2′-azobis(2-amidinopropane)dihydrochloride initiator. The mixture is sparged with N₂ for 3 h, and heated at 70° C. for 48 h. The product is precipitated with acetone and dried in vacuum. The product is treated with 1000 mL THF and centrifuged. The insoluble fraction is dried in vacuum.

### Application Results

### Formulations

All block copolymer are mixed in water solutions at 0.125 wt. % and 1 wt. % TOMADOL 91-8 and 1% NINOL 11-CM, both non-ionic surfactants.

### Determination of “Time to Wet” for Non-Woven Fabric

A treated piece of non-woven fabric is placed flat on a piece of blotter paper and a drop of de-ionized water is added to the surface using a disposable plastic pipette positioned 1 cm above the fabric. Approximately five drops are added to different parts of the fabric in this manner and the time is recorded for the drop to be absorbed into the fabric.

### Surface Treatment of Polypropylene Non-Woven Fabric

### Room Temperature Treatment

A 4 cm×4 cm piece of polypropylene non-woven (40 g/m2) is weighed prior to modification. A solution of 0.125% block copolymer from example 3 and block copolymer from example 4 in 1% TOMADOL 91-8 and 1% NINOL 11-CM (10 ml) is added to a small jar with a screw on lid. The non-woven swatch is placed in the solution and the container is shaken briefly and allowed to stand for 5 min. The swatch is then removed with a pair of forceps and rinsed for 1 minute under a flowing de-ionized water tap with spray nozzle attachment. The sample is then squeezed to remove excess water and allowed to air dry. Similar swatches are treated with two different cationic surfactants as a comparison. As shown in the table below, the block copolymer treated swatches wet rapidly with water while the swatches treated with cationic surfactant or non-ionic surfactant alone are completely hydrophobic.

TABLE I

| Treatment Solution | Time to Wet (s) |
|---|---|
| 0.125% Example 3 | 1 |
| (in 1% TOMADOL 91-8, 1% NINOL 11- | |
| CM) | |
| 0.125% | 3 |
| Example 4 | |
| (in 1% TOMADOL 91-8, 1% NINOL 11- | |
| CM) | |
| 1% TOMADOL 91-8, 1% NINOL 11- | No wet |
| CM | |
| (non-ionic surfactants only) | |
| 1.0% BTC 50NF | No wet |
| (n-alkyl dimethyl benzyl ammonium | |
| chloride) | |
| 1.0% Incroquat Behenyl HE | No wet |
| (hydroxyethyl behenylamidopropyl | |
| dimonium chloride) | |
| Untreated | No wet |

### Treatment at 60° C.

A 4 cm×4 cm piece of polypropylene non-woven (40 g/m2) is weighed prior to modification. A solution of 0.125% polymer formed in example 1 in 1% TOMADOL 91-8 and 1% NINOL 11-CM (5 ml) is added to a small jar with a screw on lid. The jar is sealed and placed in a convection oven to preheat the solution to 60° C. Once the temperature is achieved, the non-woven swatch is placed in the solution and the container is sealed, shaken briefly, and placed back in the oven for 30 min. After the desired treatment time, the swatch is removed with a pair of forceps and rinsed for 1 minute under a flowing de-ionized water tap with spray nozzle attachment. The sample is then squeezed to remove excess water and allowed to air dry. The time to wet for swatches treated for 30 min at 60° C. are shown below. Treatment with block copolymer resulted in a rapidly wettable non-woven, while treatment with quaternary surfactants did not produce a durable surface modification, as shown in the Table II below.

TABLE II

| Treatment Solution | Time to Wet (s) |
|---|---|
| 0.125% example 1 | 6 |
| (in 1% TOMADOL 91-8, 1% NINOL 11- | |
| CM) | |
| 1% TOMADOL 91-8, 1% NINOL 11- | No wet |
| CM | |
| (non-ionic surfactants only) | |
| 1.0% BTC 50NF | No wet |
| (n-alkyl dimethyl benzyl ammonium | |
| chloride) | |
| 1.0% INCROQUAT Behenyl HE | No wet |
| (hydroxyethyl behenyamidopropyl | |
| dimonium chloride) | |
| Untreated | No wet |

### 60° C. for Varying Time

Swatches of polypropylene non-woven fabric are treated with block copolymer of example 1 as described above, but the time of treatment is varied from 15 sec to 60 min as shown below. Rapidly wettable surfaces (time to wet <15 s) are produced with all treatment times, including as low as 15 s.

TABLE III

| Time at 60° C. | % Increase | Time to Wet |
|---|---|---|
| (min) | in Weight | (s) |
| 60 | 11 | 15 |
| 30 | 10 | 6 |
| 15 | 12 | 6 |
| 5 | 4 | 3 |
| 1 | 4 | 2 |
| 0.25 | 3 | 2 |
| Untreated | — | >300 |

### Varying Temperature

Swatches of polypropylene non-woven fabric are treated with block copolymer of example 1 as above, but the temperature of treatment is varied from 30° C. to 75° C. Each swatch is treated for 5 min at the temperature shown below. Rapidly wettable surfaces are produced using treatment temperatures of 60° C. or 75° C.

TABLE IV

| Temp of Treatment | % Increase | Time to Wet |
|---|---|---|
| (deg C.) | in Weight | (s) |
| 30 | 0.5 | >300 |
| 45 | 0.8 | 154 |
| 60 | 0.9 | 2 |
| 75 | 0.8 | 3 |
| Untreated | — | >300 |

### Treatment of Solid Plastic Substrates

[0.125 wt. % of the block copolymers are dissolved in solutions of 1% TOMADOL 91-8 and 1% NINOL 11-CM.]

### Dip Treatment

Plastic substrates are cleaned in a dishwasher or washed by hand with soap and water, rinsed with de-ionized water, and allowed to air dry. The cleaned substrates are dipped into a solution of polymer for 1 min, then removed and immediately rinsed with flowing de-ionized water for five seconds on each side. The substrate is then allowed to air dry. Contact angles are measured using a KRUSS DSA-10 prop Shape Analyzer using water as a probe solution. As indicated in the table below, surfaces of HDPE, Plexiglas (PMMA), and polycarbonate are treated with two different block copolymers (examples 1 and 2) demonstrated significantly lower contact angles versus surfaces treated with the surfactants only (1% TOMADOL 91-8 and 1% NINOL 11-CM). Values reported in the table are averages of a minimum of three measurements on each surface.

TABLE V

| | Material | | | | | |
|---|---|---|---|---|---|---|
| | HDPE | | Plexiglass | | Polycarbonate | |
| | | Un- | | Un- | | Un- |
| | Treated | treated | Treated | treated | Treated | treated |
| Example 1 | 77.9 | 98.1 | 58.5 | 79.4 | 60.8 | 73.1 |
| Example 2 | 80.2 | 98.4 | 62.6 | 77.5 | 65.0 | 71.4 |
| Surfactant Only | 97.1 | 99.9 | 72.7 | 74.2 | 71.3 | 77.0 |

### Solid Plastic Treatment by Wipe

Additional treatment of plastic substrates with different polymers are carried out using the same procedure as above, except solutions (2 mL) are first added to a folded paper towel then wiped onto the clean plastic substrates for 30 s. The substrates are then rinsed for 30 s with de-ionized water to remove any excess polymer and then are allowed to air dry. Contact angles for treated and untreated surfaces are reported below.

TABLE VI

| | Material | | | | | | | |
|---|---|---|---|---|---|---|---|---|
| | HDPE | | Polypropylene | | Vinyl Tile | | Polycarbonate | |
| | Treated | Untreat. | Treated | Untreat. | Treated | Untreat. | Treated | Untreat. |
| Example 3 | 62.6 | 96.8 | 84.8 | 99.5 | 69.4 | 79.9 | 71.7 | 67.1 |
| Example 4 | 90.6 | 99.3 | 93.7 | 104.6 | 73.2 | 74.0 | 65.0 | 71.0 |
| Example 5 | 85.8 | 95.1 | 96.5 | 100.1 | 71.2 | 83.8 | 63.2 | 73.2 |
| Surfactant | 95.8 | 96.8 | 101.6 | 104.3 | 69.1 | 79.9 | 71.0 | 68.1 |
| only | | | | | | | | |

1. A method for improving the wettability/hydrophilicity of a hydrophobic substrate comprising the steps of
applying a composition comprising an amphiphilic block copolymer to the substrate, wherein the amphiphilic block copolymer comprises a hydrophilic (A) block and a hydrophobic (B) block, wherein the hydrophilic block (A) comprises at least a cationic monomer unit defined by formula (I) or (II) 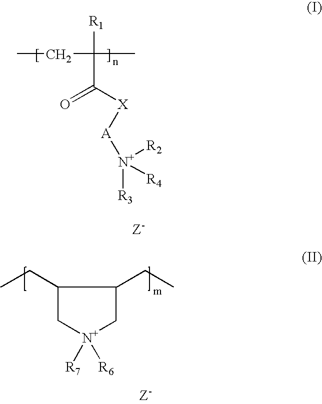
wherein R₁ is hydrogen or methyl,
R₂ is a branched or unbranched C₁₋₄ alkyl,
R₃ and/or R₄ are independently branched or unbranched C₁₋₂₂alkyl, C₁-C₄ alkylhydroxy or benzyl
or
R₃ and R₄ can be combined to form a five or six membered ring with the nitrogen, said ring containing one or more hetero atoms,
Z⁻ is the conjugate base of an acid,
X is oxygen or —NR₅,
wherein R₅ is as defined in R₁ above,
A is an alkylene group of 1 to 4 carbons,
R₆ and R₇ are branched or unbranched C₁₋₂₂ alkyl, benzyl or C₁-C₄ alkylhydroxy,
n and m are 2 or greater;
and
the hydrophobic polymeric block (B) is formed from ethylenically unsaturated hydrophobic monomers.

2. The method according to claim 1, wherein the hydrophobic block (B) is formed from hydrophobic olefinic monomers or hydrophobic ethylenically unsaturated vinyl monomers.

3. The method according to claim 1, wherein the hydrophobic block (B) is formed from at least one monomer selected from the group of monomers consisting of ethylene, propylene, 1-butene, 2-methyl-1-butene, 2-butene, isobutylene, butadiene, isoprene, pentene, 4-methyl-1-pentene, 1-hexene, 1-octente, 1-decene, 1-octadecene, vinyl cyclohexene, cyclopentadiene, β-pinene, styrene, alpha-methyl styrene, p-chlorostyrene, p-methyl styrene, a monomer defined by formula (V) 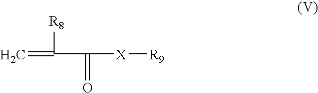
wherein R₈ is hydrogen or methyl,
R₉ is a branched or unbranched C₁₋₂₂alkyl, aryl or benzyl,
X is oxygen or —NR₅ wherein R₅ is defined as in claim 1;
and mixtures thereof.

4. The method according to claim 1, wherein monomer units of formula (I) and (II) are formed from monomers selected from the group consisting of dimethylaminoethyl acrylate, dimethylaminoethylmethacrylate, dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl methacrylate methyl sulfate quaternary salt, dimethylaminoethyl methacrylate benzyl chloride quaternary salt, diethylaminoethyl acrylate, diethylaminoethyl methacrylate, diethylaminoethyl acrylate methyl chloride quaternary salt, diethylaminoethyl methacrylate methyl chloride quaternary salt, methacrylamidopropyldimethylamine, methacrylamidopropyltrimethylammonium chloride, acrylamidopropyldimethylamine, acrylamidopropyltrimethylammonium chloride, dimethylaminopropylacrylamide methyl sulfate quaternary salt, diallylamine, diallymethylamine, diallydimethyl ammonium chloride, diallyldimethylammonium bromide, diallyldimethylammonium sulfate, diallydimethylammonium phosphate, diallyldi(beta-hydroxyethyl)ammonium chloride and diallylmethylbenzylammonium chloride.

5. The method according to claim 3, wherein the R₉ is C₆-C₂₂ alkyl.

6. The method according to claim 1, wherein the amphiphilic block copolymer is dispersible in an aqueous solution.

7. The method according to claim 1, wherein the amphiphilic block copolymer is linear, grafted, comb, crosslinked or star architecture.

8. The method according to claim 6, wherein the aqueous solution further contains a nonionic or ionic surfactant.

9. The method according to claim 1, wherein the hydrophobic substrate is a fiber, non-woven, carpet or fabric.

10. The method according to claim 1, wherein the hydrophobic substrate is a non-woven or an hydrophobic plastic.

11. The method according to claim 10, wherein the non-woven is formed from a polyolefin or a polyester.

12. The method according to claim 10, wherein the hydrophobic plastic is a hard surface and the hydrophobic plastic is selected from the group consisting of polyalkylene terephthalate, high density polyethylene, polyvinyl chloride, low density polyethylene, polypropylene, polycarbonate, polystyrene, melamine polymers, polymethylmethacrylate (plexiglass), TEFLON and mixtures thereof.

13. The method according to claim 9, wherein the hydrophobic substrate is a carpet or fabric formed from synthetic fibers and the fibers are formed from polyolefins, polyamides, polyesters or polyacrylonitriles.

14. The method according to claim 13, wherein the polyolefin is polypropylene.

15. The method according to claim 13, wherein the polyester is polyethylene terephthalate or polybutylene adipate.

16. A hard surface cleaner comprising the amphiphilic block copolymer of claim 1, wherein the block copolymer is dispersed in a aqueous solution further containing a nonionic surfactant.

17. A method of hard surface cleaning, which method comprises contacting a hydrophobic
surface with an effective amount of a cleaning formulation comprising the amphiphilic block copolymer according to claim 1.

18. A fiber, non-woven, carpet or fabric coated with the block copolymer according to claim 1.

19. A method of improving the dyeability of a non-woven by coating the non-woven with an
amphiphilic block copolymer according to claim 1.

20. A method for preparing an amphiphilic block copolymer according to claim 1, comprising the steps of
polymerizing a cationic monomer of formula (III) or (IV) 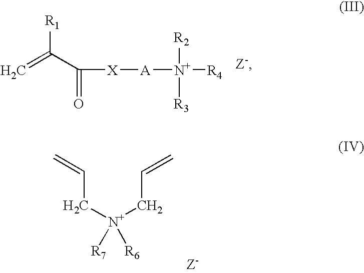
in the presence of
an hydrophobic (B) block polymer, which hydrophobic (B) block is terminated with a functional group or chain transfer group.
